(19) United States
(12) Patent Application Publication
(10) Pub. No.: US 2010/0319471 A1
(43) Pub. Date: Dec. 23, 2010

(54) RACK ASSIST TYPE ELECTRIC POWER STEERING SYSTEM

(75) Inventors: Gung-joo NAM, Wonju-si (KR); Il-yong Kim, Suwon-si (KR)

Correspondence Address: MCDERMOTT WILL & EMERY LLP, 600 13TH STREET, N.W., WASHINGTON, DC, 20005-3096, US

(73) Assignee: MANDO CORPORATION

(21) Appl. No.: 12/818,312

(22) Filed: Jun. 18, 2010

(30) Foreign Application Priority Data
Jun. 22, 2009 (KR) 10-2009-0055461

(51) Int. Cl. F16H 25/20

(52) U.S. Cl. 74/89.23

(57) ABSTRACT

A rack assist type electric power steering system has a durable and simplified structure with reduced parts and has an improved productivity, so as to reduce the manufacturing cost thereof and remarkably reduce an assembling difficulty thereof.

### BACKGROUND OF THE INVENTION

1. Field of the Invention

The present invention relates to a rack assist type electric power steering system. In particular, the present invention relates to a rack assist type electric power steering system, which has a fixing protuberance integrally formed on a surface of a damping member in contact with a retainer, wherein the surface is in close contact with a rack housing.

2. Description of the Prior Art

In general, a power steering system for generating a steering force of a vehicle is designed and operated to use the hydraulic pressure in order to enable a light, easy, smooth, and rapid steering.

The power steering system as described above allows a driver to perform the steering operation even with a small force regardless of the steering gear ratio, and can absorb an impact generated due to unevenness of the road and prevent the impact from being transferred to the driving wheel.

Recently, according to the driving condition detected by a car speed sensor, a steering torque sensor, etc., an Electronic Control Unit (ECU) is used to operate a motor to provide the driver with a light and convenient steering sense during a low speed driving, a heavy steering sense and a stable directionality, and to allow the driver to perform a rapid and instant steering under an emergency state. In other words, it is a current trend to employ an electric power steering system in order to provide drivers with optimum steering conditions.

From among the electric power steering systems, a rack assist type power steering system is an apparatus in which a driving torque generated by a motor is used for an axial movement of a rack bar. In the rack assist type power steering system, the driving torque of a motor is usually transferred through a belt and pulleys to move the rack bar in the axial direction.

In order to receive the driving torque of a motor and move the rack bar in the axial direction, a ball nut rotating together with a pulley is used. At this time, one side of the ball nut and the pulley is supported by a bearing in order to facilitate the rotation.

As shown in FIG. 1, a conventional rack assist type power steering system includes a driving means 1, which generates a power and is controlled by an Electronic Control Unit (ECU) determining a steering degree of a steering wheel (W) through a sensor (S) mounted on the top of a steering column (C), a rack assembly (R) for moving a tie rod (T) connected to wheels according to the steering degree of the steering wheel (W), and a following means 2 for receiving the rotational force of the driving means 1, converting the rotational force to an axial moving force, and transferring the converted axial moving force to the rack assembly (R).

As shown in FIG. 2, the driving means 1 includes an electric motor 10 controlled by the ECU, a driving pulley fixed to a shaft of the electric motor 10, and a driving belt wound on the driving pulley 15.

Further, the following means 2 includes a ball nut 25 supporting a rack bar 20. The ball nut 25 is disposed within a rack housing 5 surrounding the rack assembly (R), and a separately formed following pulley 30 is assembled with an outer surface of the ball nut 25.

The driving pulley 15 of the electric motor 10 and the following pulley 30 of the rack bar 20 are disposed in parallel to each other. The driving belt 35 is interposed between the driving pulley 15 and the following pulley 30 to transfer the rotational force of the electric motor 10 to the rack bar 20. The rack bar 20 is moved leftward or rightward by the operation of the ball nut 25 to generate a steering assisting force.

The driving belt 35 is in contact with outer surfaces of the driving pulley 15 and the following pulley 30. It is preferred that the driving belt 35 is a timing belt, one surface of which has a predetermined serration shape. It is also preferred that each of the outer surfaces of the driving pulley 15 and the following pulley 30 also has a serration shape engaged with the serration of the driving belt 35, so as to prevent the occurrence of slipping on the outer surfaces of the driving pulley 15 and the following pulley 30 when the driving belt 35 is operated by the electric motor 10.

A power transfer structure is arranged on the inner surface of the ball nut 25 and the outer surface of the rack bar 20 so as to generate a steering assisting force by operating the rack bar 20 in the axial direction. The power transfer structure includes an outer spiral groove formed in a spiral shape with a hemispherical section on the outer surface of the rack bar 20, a ball inserted in the outer spiral groove, and an inner spiral groove formed in a spiral shape with a hemispherical section on the inner surface of the ball nut 25 corresponding to the outer spiral groove.

The ball nut 25 is a hollow tube having an inner spiral groove form on an inner surface thereof. The ball nut 25 has stepped portions formed on both sides of the outer surface thereof. The following pulley 30 is disposed around the ball nut 25 and is in close contact with the stepped portions at one side of the ball nut 25 in the axial direction. A lock nut 43 is screw-assembled with an outer surface of one end of the ball nut 25 to fix the following pulley 30.

Further, a bearing 40 is in close contact with the stepped portions at the other side of the ball nut 25 in the axial direction. The bearing 40 is fixed by a lock nut 45 screw-assembled with an outer surface of the other end of the ball nut 25.

Further, a retainer 50 surrounds the bearing 40, and the bearing 40 is also fixed by a lock screw 60 screw-assembled with an inner surface of the retainer 50.

The retainer 50 has a protrusion 90 radially protruding from an outer surface of the retainer 50. In order to reduce noise, damping members 55, each of which is an elastic member made from rubber, are formed through an attachment or molding on both sides of the protrusion 90 in the axial direction.

The damping members 55 are in close contact with one side of stepped inner surface of the rack housing 5. The damping members 55 are held by a pin 75, which is inserted in a through-hole 65 extending through the retainer 50 in the axial direction and a supporting hole 70 formed corresponding to the through-hole 65 of the retainer 50 on the inner surface of the rack housing 5.

Then, a washer 80 is disposed in close contact with the damping member 55 on the other side of the retainer 50 within the rack housing 5 and is then fixed by the lock screw 95 screw-assembled with the rack housing 5. That is, the washer 80 is disposed between the damping member 55 and the lock screw 95, so as to support the outer surface of the ball nut.

Therefore, the retainer 50 held by the pin 75 is more firmly fixed by the screw-assembling of the lock screw 95.

However, in the conventional rack assist type power steering system, the pin 75 for holding the following means 2 is inserted in the outer surface of the retainer 50 and the inner surface of the rack housing 5 in order to assemble them. Therefore, the conventional rack assist type power steering system has a complicated structure, an increased manufacturing cost, and a degraded assembling difficulty.

### SUMMARY OF THE INVENTION

Accordingly, the present invention has been made to solve the above-mentioned problems occurring in the prior art, and an object of the present invention is to provide a rack assist type electric power steering system, which has a durable and simplified structure with reduced parts and has an improved productivity, so as to reduce the manufacturing cost thereof and remarkably reduce an assembling difficulty thereof.

In order to accomplish this object, there is provided a rack assist type power steering system including: a ball nut rotatably mounted within a rack housing; a rack bar moving leftward and rightward within the rack housing according to rotation of the ball nut; a bearing disposed between and in contact with an inner surface of the rack housing and an outer surface of the ball nut in order to support the rotation of the ball nut; a retainer surrounding the bearing and having a protrusion radially protruding from an outer surface of the retainer; and damping members disposed both sides of the protrusion in an axial direction so as to absorb vibration and noise due to impact, at least one of the damping members having a fixing protuberance formed at one side thereof so as to maintain the damping members in a normal position during the rotation of the ball nut.

According to the present invention as described above, there is provided a durable rack assist type electric power steering system, which has a simplified structure with reduced parts and an improved productivity, so that it is possible to reduce the manufacturing cost and an assembling difficulty of the electric power steering system.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a construction of a conventional rack assist type power steering system;

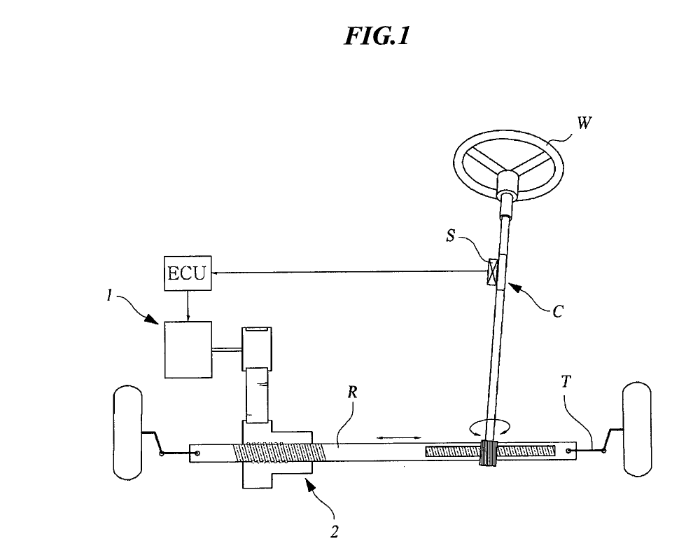

FIG. 2 is a sectional view of a conventional rack assist type power steering system;

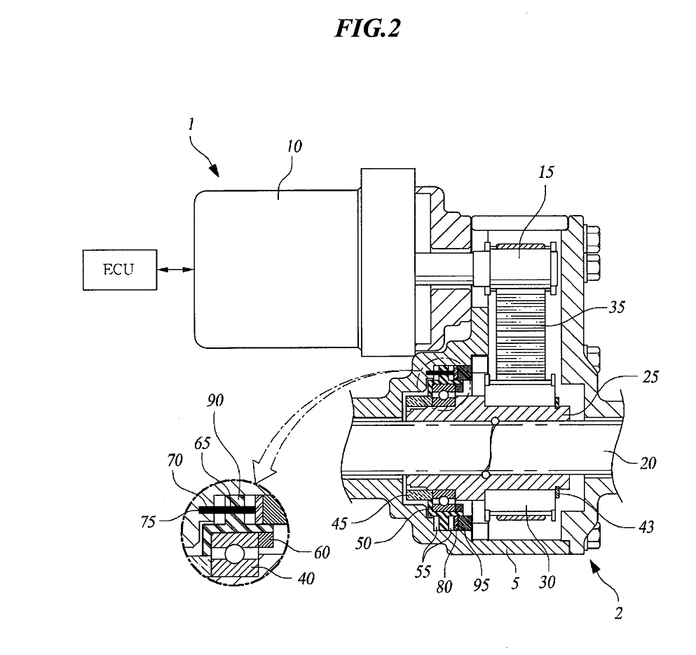

FIG. 3 is a sectional view of a rack assist type power steering system according to an exemplary embodiment of the present invention; and

FIG. 4 is an exploded perspective view of a rack assist type power steering system according to an exemplary embodiment of the present invention for showing the assembling relation between parts of the rack assist type power steering system.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted. Further, in the following description of the present invention, a detailed description of known functions and configurations incorporated herein will be omitted when it may make the subject matter of the present invention rather unclear.

In addition, it should be noted that if it is described in the specification that one component is “connected,” “coupled” or “joined” to another component, a third component may be “connected,” “coupled,” and “joined” between the first and second components, although the first component may be directly connected, assembled or joined to the second component.

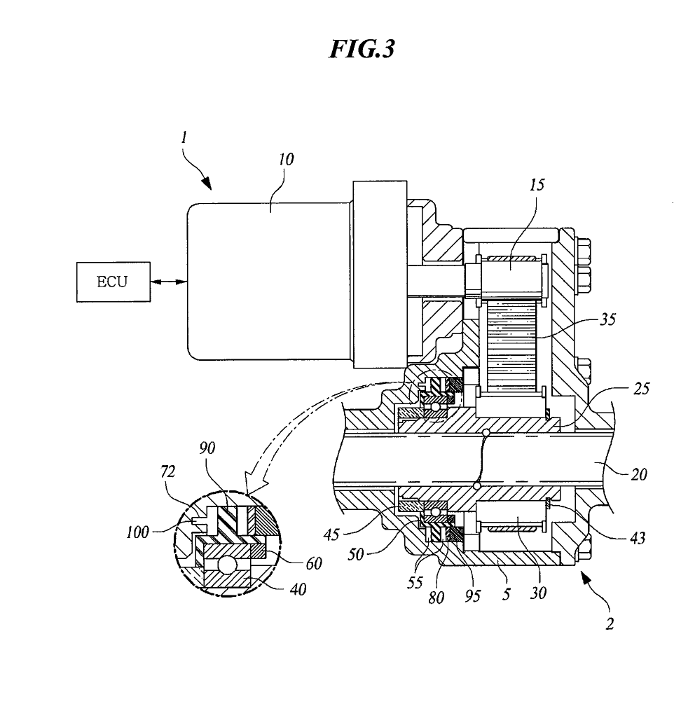

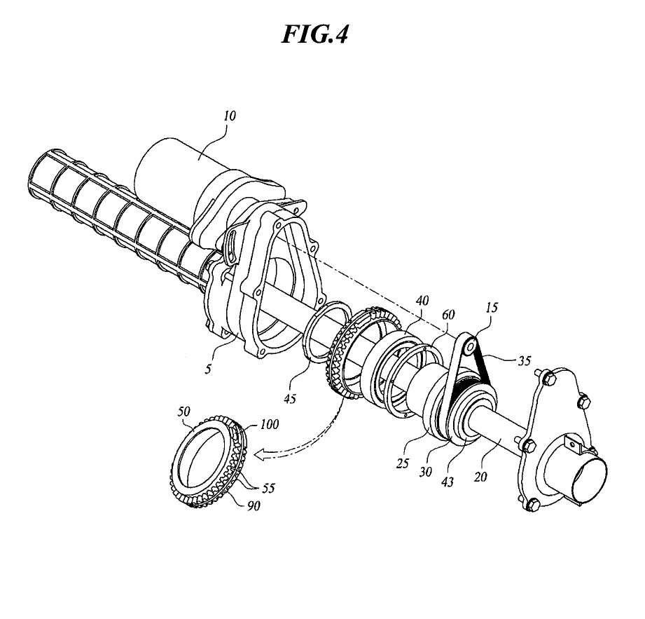

FIG. 3 is a sectional view of a rack assist type power steering system according to an exemplary embodiment of the present invention, and FIG. 4 is an exploded perspective view of a rack assist type power steering system according to an exemplary embodiment of the present invention for showing the assembling relation between parts of the rack assist type power steering system.

As shown in FIGS. 3 and 4, a rack assist type power steering system according to an exemplary embodiment of the present invention includes a driving means 1, a following means 2, and a rack assembly (R). The driving means 1 includes an electric motor 10 controlled by an ECU, a driving pulley fixed to a shaft of the electric motor 10, and a driving belt wound on the driving pulley 15.

Further, the following means 2 includes a ball nut 25 supporting a rack bar 20. The ball nut 25 is disposed within a rack housing 5 surrounding the rack assembly (R), and a separately formed following pulley 30 is assembled with an outer surface of the ball nut 25.

The driving pulley 15 of the electric motor 10 and the following pulley 30 of the rack bar 20 are disposed in parallel to each other. The driving belt 35 is interposed between the driving pulley 15 and the following pulley 30 to transfer the rotational force of the electric motor 10 to the rack bar 20. The rack bar 20 is moved leftward or rightward by the operation of the ball nut 25 to generate a steering assisting force.

The driving belt 35 is in contact with outer surfaces of the driving pulley 15 and the following pulley 30. It is preferred that the driving belt 35 is a timing belt, one surface of which has a predetermined serration shape. It is also preferred that each of the outer surfaces of the driving pulley 15 and the following pulley 30 also has a serration shape engaged with the serration of the driving belt 35, so as to prevent the occurrence of slipping on the outer surfaces of the driving pulley 15 and the following pulley 30 when the driving belt 35 is operated by the electric motor 10.

A power transfer structure is arranged on the inner surface of the ball nut 25 and the outer surface of the rack bar 20 so as to generate a steering assisting force by operating the rack bar 20 in the axial direction. The power transfer structure includes an outer spiral groove formed in a spiral shape with a hemispherical section on the outer surface of the rack bar 20, a ball inserted in the outer spiral groove, and an inner spiral groove formed in a spiral shape with a hemispherical section on the inner surface of the ball nut 25 corresponding to the outer spiral groove.

The ball nut 25 is a hollow tube having an inner spiral groove form on an inner surface thereof. The ball nut 25 has stepped portions formed on both sides of the outer surface thereof. The following pulley 30 is disposed around the ball nut 25 and is in close contact with the stepped portions at one side of the ball nut 25 in the axial direction. A lock nut 43 is screw-assembled with an outer surface of one end of the ball nut 25 to fix the following pulley 30.

Further, a bearing 40 is in close contact with the stepped portions at the other side of the ball nut 25 in the axial direction. The bearing 40 is fixed by a lock nut 45 screw-assembled with an outer surface of the other end of the ball nut 25.

Further, a retainer 50 surrounds the bearing 40, and the bearing 40 is also fixed by a lock screw 60 screw-assembled with an inner surface of the retainer 50.

The retainer 50 has a protrusion 90 radially protruding from an outer surface of the retainer 50. In order to reduce noise, damping members 55, each of which is an elastic member made from rubber, are formed through an attachment or molding on both sides of the protrusion 90 in the axial direction.

Each of the damping member 55 has a circumferential protuberance formed on one side thereof, which is in contact with the retainer 50, so as to absorb impact and reduce vibration and noise.

Further, the damping members 55 are in close contact with one side of stepped inner surface of the rack housing 5. The damping member 55 has a fixing protuberance 100 protruding in the axial direction from the surface thereof, which is in close contact with the rack housing 5, so as to maintain the damping member 55 in the normal position during the rotation of the ball nut. The fixing protuberance 100 is inserted in a supporting hole 72 formed at a location corresponding to the fixing protuberance 100 on one side of the stepped inner surface of the rack housing 5.

According to another embodiment of the present invention, more than one fixing protuberance 100 and more than one supporting hole 72 may be formed with a predetermined interval between them.

Then, a washer 80 is disposed in close contact with the damping member 55 on the other side of the retainer 50 within the rack housing 5 and is then fixed by the lock screw 95 screw-assembled with the rack housing 5. That is, the washer 80 is disposed between the damping member 55 and the lock screw 95, so as to support the outer surface of the ball nut.

Therefore, the damping member 55 having the fixing protuberance 100 formed at one side thereof is maintained at the normal position during the operation.

In a rack assist type power steering system according to an exemplary embodiment of the present invention as described above, the damping member 55 in contact with the retainer 50 has a fixing protuberance 100 integrally formed on one surface thereof in close contact with the rack housing 5. Therefore, the rack assist type power steering system according to an exemplary embodiment of the present invention has durability, a simplified structure with reduced parts, and an improved productivity, so as to reduce the manufacturing cost thereof and remarkably reduce an assembling difficulty thereof.

Even if it was described in the above that all of the components of an embodiment of the present invention are coupled as a single unit or coupled and operated as a single unit, the present invention is not limited to such an embodiment. That is, within the purpose of the present invention, all of the components may be selectively coupled and operated as one or more units.

In addition, since terms, such as “including,” “including,” and “having” mean that one or more corresponding components may exist unless they are specifically described to the contrary, it shall be construed that one or more other components can be included.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiment disclosed in the present invention is intended to illustrate the scope of the technical idea of the present invention, and the scope of the present invention is not limited by the embodiment. The scope of the present invention shall be construed on the basis of the accompanying claims, and it shall be construed that all of the technical ideas included within the scope equivalent to the claims belong to the present invention.

What is claimed is:

1. A rack assist type power steering system comprising:
a ball nut rotatably mounted within a rack housing;
a rack bar moving leftward and rightward within the rack housing according to rotation of the ball nut;
a bearing disposed between and in contact with an inner surface of the rack housing and an outer surface of the ball nut in order to support the rotation of the ball nut;
a retainer surrounding the bearing and having a protrusion radially protruding from an outer surface of the retainer; and
damping members disposed both sides of the protrusion in an axial direction so as to absorb vibration and noise due to impact, at least one of the damping members having a fixing protuberance formed at one side thereof so as to maintain the damping members in a normal position during the rotation of the ball nut.

2. The rack assist type power steering system of claim 1, wherein more than one fixing protuberance protrudes in the axial direction of the damping members.

3. The rack assist type power steering system of claim 1, wherein a supporting hole is formed corresponding to the fixing protuberance on one side of a stepped portion of the rack housing so that the fixing protuberance is engaged with the supporting hole.
